(19) United States
(12) Patent Application Publication
(10) Pub. No.: US 2022/0106428 A1
(43) Pub. Date: Apr. 7, 2022

(54) POLYETHER COMPOSITION, LOW VOC POLYURETHANE FOAM AND PREPARATION METHOD THEREFOR

(71) Applicant: Juyuan Chemical Industry Co., Ltd., Jilin City, Jilin (CN)

(72) Inventor: Yanqun Li, Jilin City, Jilin (CN)

(21) Appl. No.: 17/424,692

(22) PCT Filed: Jan. 21, 2020
(86) PCT No.: PCT/CN2020/073586

§ 371 Date: Jul. 21, 2021

(30) Foreign Application Priority Data
Jan. 21, 2019 (CN) 201910054475.1

(51) Int. Cl. C08G 18/08; C08G 18/12; C08G 18/20; C08G 18/18; C08G 18/32; C08G 18/44; C08G 18/48; C08G 18/66; C08G 18/76; C08J 9/12; C08J 9/14

(52) U.S. Cl. CPC C08G 18/14; C08G 18/12; C08G 18/2027; C08G 18/1833; C08G 18/3275; C08G 18/44; C08G 2101/00; C08G 18/6622; C08G 18/7671; C08G 18/7621; C08J 9/125; C08J 9/141; C08G 2110/005; C08G 18/48

(57) ABSTRACT

A polyether composition for a polyurethane foam is provided, comprising a polyether polyol and a polyether carbonate polyol that has a primary hydroxyl group molar content of not less than 40 mol %. A method for preparing a polyurethane foam is further provided, comprising the following steps: preparing a mixture by preheating and melting the polyether composition for a polyurethane foam, a foaming agent, a chain extender, a catalyst, a pore-forming agent and a foam stabilizer, and mixing well; cooling the mixture; and performing a polymerization reaction by adding an isocyanate to the cooled mixture and mixing, thus obtaining a polyurethane foam product. The use of the polyether carbonate polyol with the primary hydroxyl group molar content of not less than 40 mol % overcomes the defects of unstable performance of polyurethane and poor mechanical properties of products when the VOC content of the polyurethane foam is reduced by adding additives in the prior art.

### FIELD OF THE INVENTION

The present invention relates to the technical field of polymer materials, and specifically, to a polyether composition, a low-VOC polyurethane foam and a preparation method thereof.

### BACKGROUND OF THE INVENTION

Polyurethane foams are polymerized by polyols and isocyanates in the presence of catalysts, foaming agents, chain extenders, pore-forming agents and other additives. The polyurethane foams are divided into rigid polyurethane foams and flexible polyurethane foams. The flexible polyurethane foams have the characteristics of light weight, high resilience, good comfort, durability, sound insulation, relatively high shock absorption, etc., and therefore, have been widely used in seats, backrests, headrests, armrests and sound and vibration isolation systems of automobiles and furniture such as sofas and mattresses. As people's requirements for quality of life and environmental protection are increasing, volatile organic compounds (VOC) in the polyurethane foams have received more and more attention.

Chinese patent document CN104151540A provides a method for preparing a polyether polyol with low VOC content, which reduces the production of by-products. In Chinese patent CN101240055B, a polyurethane foam with low VOC content is prepared by retreating a polyether polyol and using a low odor catalyst, a low atomizing silicone oil and a low volatile content isocyanate. In Chinese patent document CN105418882A, a low-VOC polyurethane foam is prepared from a polyether polyol, a modified isocyanate, a low-emission silicone oil, a low-emission catalyst, triethanolamine, diethanolamine and water at a specific ratio. The polyurethane foams prepared by the above patents only reduce the VOC content from the raw materials, but the polyurethane foams still produce a relatively high content of VOC during the preparation, storage and use, which pollutes the environment and affects daily use.

Chinese patent document CN105111397A introduces a low-VOC and high-resilience polyurethane foam composition and a preparation method thereof, wherein the method is implemented by adding an aldehyde trapping agent to a composition. Chinese patent document CN1517378A reduces VOC volatilization of a polyurethane foam prepared using a high molecular compound below a certain molecular weight as an antioxidant during synthesis.

Although the above patents reduce the VOC of the polyurethane foam to a certain extent, the use of the aldehyde trapping agent or the antioxidant is an additional method, and its addition amount is small, so the effect is not obvious. If the addition amount is large, the mechanical properties will be affected, causing unstable performance of polyurethane and poor mechanical properties of products. In addition, the cost is also increased.

### SUMMARY OF THE INVENTION

Therefore, the technical problem to be solved by the present invention is to overcome the defects of unstable performance of polyurethane and poor mechanical properties of products when the VOC content of a polyurethane foam is reduced by adding additives in the prior art, thereby providing a polyether composition, a low-VOC polyurethane foam and a preparation method thereof.

The present invention provides a polyether composition for a polyurethane foam, comprising a polyether polyol and a polyether carbonate polyol that has a primary hydroxyl group molar content of not less than 40 mol %.

Preferably, the polyether carbonate polyol has a primary hydroxyl group molar content of from 50 mol % to 95 mol %.

Further, a mass ratio of the polyether carbonate polyol to the polyether polyol is (5-100):(1-95); and preferably, a mass ratio of the polyether carbonate polyol to the polyether polyol is (30-65):(35-70). Further, the polyether carbonate polyol has a molecular weight of from 500 g/mol to 10000 g/mol, a carbonate content of from 5 wt % to 99 wt %, and a functionality degree of from 2 to 8; and preferably, the polyether carbonate polyol has a molecular weight of from 2000 g/mol to 8000 g/mol, a carbonate content of from 20 wt % to 80 wt %, and a functionality degree of from 2 to 6.

The present invention further provides use of the polyether composition for a polyurethane foam in preparation of the polyurethane foam.

The present invention further provides a method for preparing a polyurethane foam, comprising the following steps:

preparing a mixture by preheating and melting the polyether composition for a polyurethane foam, a foaming agent, a chain extender, a catalyst, a pore-forming agent and a foam stabilizer, and mixing well,
cooling the mixture, and
performing a polymerization reaction by adding an isocyanate to the cooled mixture and mixing, thus obtaining a polyurethane foam product.

Further, the isocyanate is selected from one or more of hexamethylene diisocyanate, methylcyclohexyl diisocyanate, dicyclohexylmethane diisocyanate, toluene diisocyanate, methylenediphenyl diisocyanate, p-phenylene diisocyanate, polymethylene polyphenyl polyisocyanate, 3,5-dimethyl 4,4-diphenylmethane diisocyanate, 2,4-ethylbenzene diisocyanate, 3,3-dimethoxy 4,4-diphenylmethane diisocyanate, toluene diisocyanate dimer, isophorone diisocyanate, xylylene diisocyanate, 1,5-naphthalene diisocyanate and tetramethylxylylene diisocynate;

preferably, the chain extender is selected from one or more of ethylene glycol, 1,2-propanediol, 1,3-propanediol, 1,4-butanediol, diethylene glycol, 1,7-heptanediol, 1,8-octanediol, glycerol, trimethylolpropane, 1,4-cyclohexanediol, hydrogenated bisphenol A, diethanolamine, triethanolamine, methyldiethanolamine, 3,3-dichloro-4,4-diphenylmethane, diethyltoluenediamine, 3,5-dimethylthiotoluenediamine, glycerol alpha-monoallyl ether, glycidyl allyl ether and dicumyl peroxide; and
preferably, the catalyst is selected from one or more of organotin catalysts and organic amine catalysts.

Further, said preheating and melting comprise, heating from room temperature to a temperature of 40-100° C. at a constant speed within 0.5 to 1.5 hours while increasing a stirring speed from 80-120 rpm to 800-1200 rpm at a constant speed, and maintaining the stirring at 800 to 1200 rpm for a further 1.5 to 2.5 hours, followed by cooling to room temperature.

Preferably, said performing a polymerization reaction comprises carrying out stirring at a speed of 1500 rpm to 2000 rpm for the beginning 5-10 seconds to obtain a reaction mixture, and placing the reaction mixture to a mold to continue the polymerization reaction for 3 min to 20 min at a temperature of 30-100° C.

The present invention further provides a polyurethane foam prepared according to the above method. The technical solution of the present invention has the following advantages:

1. The polyether composition for a polyurethane foam according to the present invention comprises a polyether carbonate polyol and a polyether polyol, and the polyether carbonate polyol has a high primary hydroxyl group molar content of not less than 40 mol %. The combination of the polyether carbonate polyol with high primary hydroxyl molar content and the polyether polyol to prepare a polyurethane foam overcomes the problems of unstable performance of polyurethane, high VOC content, and poor mechanical properties of products in the presence of a large amount of unstable and easy-to-break ether-oxygen bonds when the polyether polyol is used alone. In addition, the prepared polyurethane foam has the characteristics of low density and high elasticity, and can thus be promoted and used.
2. In the polyether composition for a polyurethane foam according to the present invention, it is found by research that the polyether carbonate polyol with too low carbonate content slightly increases the VOC content of the polyurethane foam prepared therefrom, while the polyether carbonate polyol with too high carbonate content leads to relatively hard physical and mechanical properties and poor resilience of the polyurethane foam prepared therefrom. After a limited number of screenings, the present invention adopts a polyether carbonate polyol with a carbonate content of from 20 wt % to 80 wt %. Due to the moderate carbonate content, the polyurethane foam prepared therefrom can obtain appropriate physical and mechanical properties, and has a relatively low VOC content.
3. In the method for preparing a polyurethane foam according to the present invention, the preheating and melting process is controlled by heating from room temperature to a temperature of 40-100° C. at a constant speed within 0.5 to 1.5 hours while increasing a stirring speed from 80-120 rpm to 800-1200 rpm at a constant speed, and maintaining the stirring at 800 to 1200 rpm for a further 1.5 to 2.5 hours, followed by cooling to room temperature, which can further change the unstable performance of the polyurethane foam and improve the mechanical properties of the product.

### DETAILED DESCRIPTION OF EMBODIMENTS

The following examples are provided for a better understanding of the present invention, are not limited to the best embodiment, and do not limit the content and protection scope of the present invention. Any identical or similar product obtained by any person under the enlightenment of the present invention or by combining the features of the present invention and other existing technologies shall fall within the protection scope of the present invention.

Main reagents of the present invention are as follows:

Polyether carbonate polyol was provided by Changchun Institute of Applied Chemistry, Chinese Academy of Sciences, and the primary hydroxyl group molar content therein was calculated in mole percentage, mol %. Modified diphenylmethane diisocyanate (modified MDI) was purchased from Yantai Wanhua Polyurethane Co., Ltd. Polyether polyol F2831, polyether polyol 330N and pore-forming agent F-1251 were purchased from Jilin Juyuan Chemical Industry Co., Ltd. Bis(2-dimethylaminoethyl) ether (Niax-Al) catalyst was purchased from Union Carbide Corporation. Organosilicone foam stabilizer B8681 was purchased from Evonik, Germany. Catalyst TEDA33 (a catalyst prepared from 33% of triethylenediamine and 67% of ethylene glycol) was purchased from Tosoh, Japan, etc.

### Example 1

50 g of dried polyether carbonate polyol (with a molecular weight of 6000 g/mol and a functionality degree of 3) containing 60.0 mol % of primary hydroxyl groups and 55 wt % of carbonate, 50 g of polyether polyol F2831, 0.25 g of catalyst TEDA33, 0.8 g of chain extender diethanolamine, 0.1 g of catalyst Niax-Al, 3 g of pore-forming agent F-1251, 0.7 g of foam stabilizer B8681, and 3.6 g of water were mixed well to obtain a mixture, the mixture was heated from room temperature to a temperature of 50° C. at a constant speed within 1 hour while a stirring speed was slowly increased from 100 rpm to 1000 rpm, the stirring was maintained at 1000 rpm for a further 2 hours, the mixture was cooled to room temperature, 56.21 g of modified MDI was added, the mixture was stirred at a speed of 2000 rpm for 8 s, a mold was preheated to a temperature of 50° C., the mixture was placed to the mold and then reacted at the temperature of 50° C. for 10 min, and the mold was opened to obtain a polyurethane foam product.

### Example 2

65 g of dried polyether carbonate polyol (with a molecular weight of 4000 g/mol and a functionality degree of 3) containing 45.0 mol % of primary hydroxyl groups and 30 wt % of carbonate, 35 g of polyether polyol 330N, 0.50 g of catalyst TEDA, 0.5 g of chain extender triethanolamine, 0.1 g of catalyst Dabco120, 6 g of pore-forming agent F-1251, 0.7 g of foam stabilizer B8681, and 4.2 g of water were mixed well to obtain a mixture, the mixture was heated from room temperature to a temperature of 100° C. at a constant speed within 0.5 hour while a stirring speed was slowly increased from 80 rpm to 1200 rpm, the mixture was stirred for 1.5 hours and cooled to room temperature, 58 g of hexamethylene diisocyanate was added, the mixture was stirred at a speed of 1500 rpm for 5 s, a mold was preheated to a temperature of 100° C., the mixture was placed to the mold and then reacted at the temperature of 100° C. for 3 min, and the mold was opened to obtain a polyurethane foam product.

### Example 3

30 g of dried polyether carbonate polyol (with a molecular weight of 2000 g/mol and a functionality degree of 3) containing 95.0 mol % of primary hydroxyl groups and 70 wt % of carbonate, 70 g of polyether polyol 330N, 0.25 g of catalyst TEDA, 0.8 g of chain extender hydrogenated bisphenol A, 0.1 g of catalyst bis(2-dimethylaminoethyl) ether, 3 g of pore-forming agent PUY-603, 0.7 g of foam stabilizer B8462, and 3.0 g of water were mixed well to obtain a mixture, the mixture was heated from room temperature to a temperature of 40° C. at a constant speed within 1.5 hours while a stirring speed was slowly increased from 120 rpm to 800 rpm, the mixture was stirred for 2.5 hours and cooled to room temperature, 53 g of xylylene diisocynate was added, the mixture was stirred at a speed of 1800 rpm for 10 s, placed to a mold and then reacted at a temperature of 30° C. for 20 min, and the mold was opened to obtain a polyurethane foam product.

### Example 4

50 g of dried polyether carbonate polyol (with a molecular weight of 6000 g/mol and a functionality degree of 3) containing 60 mol % of primary hydroxyl groups and 15 wt % of carbonate, 50 g of polyether polyol F2831, 0.25 g of catalyst TEDA33, 0.8 g of chain extender diethanolamine, 0.1 g of catalyst Niax-Al, 3 g of pore-forming agent F-1251, 0.7 g of foam stabilizer B8681, and 3.6 g of water were mixed well to obtain a mixture, the mixture was quickly heated from room temperature to a temperature of 50° C. within 1 hour while a stirring speed was quickly increased from 100 rpm to 1000 rpm, the stirring was maintained at 1000 rpm for a further 2 hours, the mixture was cooled to room temperature, 56.21 g of modified MDI was added, the mixture was stirred at a speed of 2000 rpm for 8 s, a mold was preheated to a temperature of 50° C., the mixture was placed to the mold and then reacted at the temperature of 50° C. for 10 min, and the mold was opened to obtain a polyurethane foam product.

### Example 5

50 g of dried polyether carbonate polyol (with a molecular weight of 6000 g/mol and a functionality degree of 3) containing 45 mol % of primary hydroxyl groups and 55 wt % of carbonate, 50 g of polyether polyol F2831, 0.25 g of catalyst TEDA33, 0.8 g of chain extender diethanolamine, 0.1 g of catalyst Niax-Al, 3 g of pore-forming agent F-1251, 0.7 g of foam stabilizer B8681, and 3.6 g of water were mixed well to obtain a mixture, the mixture was heated from room temperature to a temperature of 50° C. at a constant speed within 1 hour while a stirring speed was slowly increased from 100 rpm to 1000 rpm, the stirring was maintained at 1000 rpm for a further 2 hours, the mixture was cooled to room temperature, 56.21 g of modified MDI was added, the mixture was stirred at a speed of 2000 rpm for 8 s, a mold was preheated to a temperature of 50° C., the mixture was placed to the mold and then reacted at the temperature of 50° C. for 10 min, and the mold was opened to obtain a polyurethane foam product.

### Example 6

15 g of dried polyether carbonate polyol (with a molecular weight of 6000 g/mol and a functionality degree of 3) containing 60 mol % of primary hydroxyl groups and 55 wt % of carbonate, 85 g of polyether polyol F2831, 0.25 g of catalyst TEDA33, 0.8 g of chain extender diethanolamine, 0.1 g of catalyst Niax-Al, 3 g of pore-forming agent F-1251, 0.7 g of foam stabilizer B8681, and 3.6 g of water were mixed well to obtain a mixture, the mixture was heated from room temperature to a temperature of 50° C. at a constant speed within 1 hour while a stirring speed was slowly increased from 100 rpm to 1000 rpm, the stirring was maintained at 1000 rpm for a further 2 hours, the mixture was cooled to room temperature, 56.21 g of modified MDI was added, the mixture was stirred at a speed of 2000 rpm for 8 s, a mold was preheated to a temperature of 50° C., the mixture was placed to the mold and then reacted at the temperature of 50° C. for 10 min, and the mold was opened to obtain a polyurethane foam product.

### Comparative Example 1

100 g of polyether polyol F2831, 0.25 g of catalyst TEDA33, 0.8 g of chain extender diethanolamine, 0.1 g of catalyst Niax-Al, 3 g of pore-forming agent F-1251, 0.7 g of foam stabilizer B8681, and 3.6 g of water were mixed well to obtain a mixture, the mixture was heated from room temperature to a temperature of 50° C. at a constant speed within 1 hour while a stirring speed was slowly increased from 100 rpm to 1000 rpm, the stirring was maintained at 1000 rpm for a further 2 hours, the mixture was cooled to room temperature, 56.21 g of modified MDI was added, the mixture was stirred at a speed of 2000 rpm for 8 s, a mold was preheated to a temperature of 50° C., the mixture was placed to the mold and then reacted at the temperature of 50° C. for 10 min, and the mold was opened to obtain a polyurethane foam product.

### Comparative Example 2

A polyurethane foam was prepared according to the method disclosed in Example 1 of Chinese Patent Document CN105111397A. Specifically, a method for preparing a low-VOC and high-resilience polyurethane foam composition comprised, preparation of a material A: 42 parts of polyether polyol and 50 parts of polymer polyol were added to a reactor and stirred, then 1 part of silicon foam stabilizer, 1.5 parts of catalyst (bis(2-dimethylaminoethyl) ether), 0.5 part of auxiliary (prepared from manganese dioxide, urea, and ethylenediamine at a mass ratio of 2:5:3), 1 part of cross-linking agent (diethanolamine), and 4 parts of foaming agent (consisting of a mixture of 1.4 parts of cyclopentane and 1.4 parts n-pentane, and 1.2 parts of pure water) were added in order, stirring was carried out at a speed of 100 r/min for 1 hour, and the material A was discharged after test indicators were qualified; preparation of a material B: 70 parts of toluene diisocyanate TDI80/20 was added into a reactor and stirred, 12 parts of liquefied MDI and 18 parts of polymerized MDI were added, indicators were tested after 1 hour, and the material B was discharged after qualified; and a mold was preheated to 60° C., 100 parts of the material A and 60 parts of the material B were quickly stirred well and poured into the mold, the mold was closed, and finally, a polyurethane foam product was released from the mold.

The polyurethane foam products prepared in Examples 1-6 and Comparative Examples 1-2 were placed for 7 days, and their performances were tested. The density (Kg/m³) was tested according to ISO845:2006, IDT standards; the compressive hardness (Kpa) was tested according to ISO2439:1997IDT standards; the tensile strength (Kpa) was tested according to ISO1798:2008, IDT standards; the tear strength (N/cm) was tested according to ISO8067:1989IDT standards; the elongation at break (%) was tested according to ISO1798:2008, IDT standards; and VOC gases (benzene, toluene, ethylbenzene, xylene, styrene, formaldehyde, acetaldehyde, and acrolein) were tested according to Q/FC-CD05-001-2013 standards. The results were shown in the following table.

TABLE 1
Performance test table of polyurethane foam products prepared in Examples 1-6 and
Comparative Examples 1-2

| | Example | Example | Example | Example | Example | Example | Comparative | Comparative |
|---|---|---|---|---|---|---|---|---|
| Test indicator | 1 | 2 | 3 | 4 | 5 | 6 | Example 1 | Example 2 |
| Density | 45 | 47.1 | 46.6 | 49.2 | 48.5 | 46 | 46.7 | 45.8 |
| (Kg/m³) | | | | | | | | |
| Compressive | 8.26 | 7.21 | 8.90 | 7.56 | 6.50 | 9.76 | 6.90 | 4.32 |
| hardness | | | | | | | | |
| (Kpa) | | | | | | | | |
| Tensile strength | 191 | 189 | 196 | 194 | 193 | 181 | 180 | 162 |
| (Kpa) | | | | | | | | |
| Tear strength | 2.91 | 2.90 | 2.99 | 2.71 | 2.85 | 2.81 | 2.78 | 2.42 |
| (N/cm) | | | | | | | | |
| Elongation at | 135 | 123 | 122 | 105 | 123 | 125 | 98 | 99 |
| break (%) | | | | | | | | |
| Benzene | ND | ND | ND | ND | ND | ND | 38 | ND |
| (μg/m³) | | | | | | | | |
| Toluene | 6.3 | 7.2 | 4.2 | 10.3 | 10.25 | 16.3 | 110 | 32 |
| (μg/m³) | | | | | | | | |
| Ethylbenzene | ND | ND | ND | ND | ND | ND | 35.5 | ND |
| (μg/m³) | | | | | | | | |
| Xylene (μg/m³) | ND | ND | ND | ND | ND | ND | 97.7 | ND |
| Styrene (μg/m³) | ND | ND | ND | ND | ND | ND | 40 | 21 |
| Formaldehyde | 26.2 | 25.9 | 23.0 | 31.2 | 32.9 | 26.21 | 154.8 | 31.2 |
| (Mg/m³) | | | | | | | | |
| Acetaldehyde | 18.2 | 22.1 | 20.9 | 30 | 29.7 | 33 | 169 | 19.1 |
| (Mg/m³) | | | | | | | | |
| Acraldehyde | ND | ND | ND | ND | ND | ND | ND | ND |
| (Mg/m³) | | | | | | | | |

It can be seen from Table 1 that, compared to Comparative Examples 1-2, Examples 1-6 of the present invention can significantly reduce the VOC content of polyurethane foams by using the polyether carbonate polyols with a high primary hydroxyl group molar content; in addition, the compressive hardness, tensile strength, tear strength, and elongation at break of the polyurethane foams of the present invention were obviously improved, and the prepared polyurethane foams had the characteristics of low density and high elasticity; moreover, compared to Examples 4-6, Examples 1-3 can further reduce the VOC content and density of the polyurethane foams and improve the tear strength, tensile strength and compressive strength by screening the appropriate primary hydroxyl group molar content, carbonate content and mass ratio of the polyether carbonate polyol to the polyether polyol.

It is apparent that the above embodiments are merely illustrative of the examples, and are not intended to limit the embodiments. Other variations or modifications of different forms may be made by those of ordinary skill in the art in light of the above description. There is no need and no way to exhaust all of the embodiments. Obvious variations or modifications resulting therefrom are still within the scope of the present invention.

1. A polyether composition for a polyurethane foam, comprising a polyether polyol and a polyether carbonate polyol that has a primary hydroxyl group molar content of not less than 40 mol %.

2. The polyether composition according to claim 1, wherein the polyether carbonate polyol has a primary hydroxyl group molar content of from 50 mol % to 95 mol %.

3. The polyether composition of claim 1, wherein a mass ratio of the polyether carbonate polyol to the polyether polyol is (5-100):(1-95); and preferably, a mass ratio of the polyether carbonate polyol to the polyether polyol is (30-65):(35-70).

4. The polyether composition of claim 1, wherein the polyether carbonate polyol has a molecular weight of from 500 g/mol to 10000 g/mol, a carbonate content of from 5 wt % to 99 wt %, and a functionality degree of from 2 to 8; and
preferably, the polyether carbonate polyol has a molecular weight of from 2000 g/mol to 8000 g/mol, a carbonate content of from 20 wt % to 80 wt %, and a functionality degree of from 2 to 6.

5. (canceled)

6. A method for preparing a polyurethane foam, comprising the following steps:
preparing a mixture by preheating and melting the polyether composition for a polyurethane foam of claim 1, a foaming agent, a chain extender, a catalyst, a pore-forming agent and a foam stabilizer, and mixing well,
cooling the mixture, and
performing a polymerization reaction by adding an isocyanate to the cooled mixture and mixing, thus obtaining a polyurethane foam product.

7. The method for preparing a polyurethane foam of claim 6, wherein the isocyanate is selected from one or more of hexamethylene diisocyanate, methylcyclohexyl diisocyanate, dicyclohexylmethane diisocyanate, toluene diisocyanate, methylenediphenyl diisocyanate, p-phenylene diisocyanate, polymethylene polyphenyl polyisocyanate, 3,5-dimethyl 4,4-diphenylmethane diisocyanate, 2,4-ethylbenzene diisocyanate, 3,3-dimethoxy 4,4-diphenylmethane diisocyanate, toluene diisocyanate dimer, isophorone diisocyanate, xylylene diisocyanate, 1,5-naphthalene diisocyanate and tetramethylxylylene diisocynate;
preferably, the chain extender is selected from one or more of ethylene glycol, 1,2-propanediol, 1,3-propanediol, 1,4-butanediol, diethylene glycol, 1,7-heptanediol, 1,8-octanediol, glycerol, trimethylolpropane, 1,4-cyclohexanediol, hydrogenated bisphenol A, diethanolamine, triethanolamine, methyldiethanolamine, 3,3-dichloro-4,4-diphenylmethane, diethyltoluenediamine, 3,5-dimethylthiotoluenediamine, glycerol alpha-monoallyl ether, glycidyl allyl ether and dicumyl peroxide; and
preferably, the catalyst is selected from one or more of organotin catalysts and organic amine catalysts.

8. The method for preparing a polyurethane foam of claim 6, wherein said preheating and melting comprise,
heating from room temperature to a temperature of 40-100° C. at a constant speed within 0.5 to 1.5 hours while increasing a stirring speed from 80-120 rpm to 800-1200 rpm at a constant speed, and maintaining the stirring at 800 to 1200 rpm for a further 1.5 to 2.5 hours, followed by cooling to room temperature.

9. The method for preparing a polyurethane foam of claim 6, wherein said performing a polymerization reaction comprises carrying out stirring at a speed of 1500 rpm to 2000 rpm for the beginning 5-10 seconds to obtain a reaction mixture, and placing the reaction mixture to a mold to continue the polymerization reaction for 3 min to 20 min at a temperature of 30-100° C.

10. A polyurethane foam prepared by the method of claim 6.

11. The polyether composition according to claim 2, wherein a mass ratio of the polyether carbonate polyol to the polyether polyol is (5-100):(1-95); and
preferably, a mass ratio of the polyether carbonate polyol to the polyether polyol is (30-65):(35-70).

12. The polyether composition of claim 2, wherein the polyether carbonate polyol has a molecular weight of from 500 g/mol to 10000 g/mol, a carbonate content of from 5 wt % to 99 wt %, and a functionality degree of from 2 to 8; and
preferably, the polyether carbonate polyol has a molecular weight of from 2000 g/mol to 8000 g/mol, a carbonate content of from 20 wt % to 80 wt %, and a functionality degree of from 2 to 6.

13. The polyether composition of claim 3, wherein the polyether carbonate polyol has a molecular weight of from 500 g/mol to 10000 g/mol, a carbonate content of from 5 wt % to 99 wt %, and a functionality degree of from 2 to 8; and
preferably, the polyether carbonate polyol has a molecular weight of from 2000 g/mol to 8000 g/mol, a carbonate content of from 20 wt % to 80 wt %, and a functionality degree of from 2 to 6.

14. The method for preparing a polyurethane foam of claim 6, wherein said preheating and melting comprise,
heating from room temperature to a temperature of 40-100° C. at a constant speed within 0.5 to 1.5 hours while increasing a stirring speed from 80-120 rpm to 800-1200 rpm at a constant speed, and maintaining the stirring at 800 to 1200 rpm for a further 1.5 to 2.5 hours, followed by cooling to room temperature.

15. The method for preparing a polyurethane foam of claim 6, wherein said performing a polymerization reaction comprises carrying out stirring at a speed of 1500 rpm to 2000 rpm for the beginning 5-10 seconds to obtain a reaction mixture, and placing the reaction mixture to a mold to continue the polymerization reaction for 3 min to 20 min at a temperature of 30-100° C.

16. The method for preparing a polyurethane foam of claim 7, wherein said performing a polymerization reaction comprises carrying out stirring at a speed of 1500 rpm to 2000 rpm for the beginning 5-10 seconds to obtain a reaction mixture, and placing the reaction mixture to a mold to continue the polymerization reaction for 3 min to 20 min at a temperature of 30-100° C.
